(19) United States
(12) Patent Application Publication
(10) Pub. No.: US 2026/0065801 A1
(43) Pub. Date: Mar. 5, 2026

(54) Universal Guitar Chord Learning System and Method

(71) Applicant: Michael Grande, Marlboro, NJ (US)

(72) Inventor: Michael Grande, Marlboro, NJ (US)

(21) Appl. No.: 18/823,737

(22) Filed: Sep. 4, 2024

(51) Int. Cl. G09B 15/00; G10G 1/02

(52) U.S. Cl. CPC G09B 15/004; G10G 1/02

(57) ABSTRACT

A universal guitar chord learning system comprising a plurality of chord cards, each having a thin, flat body configured for removable insertion between the strings and fretboard of a guitar without interfering with string vibration. The chord cards include fret-engaging notches arranged along peripheral edges, adapted to securely attach to guitar frets of varying spacings and dimensions, thereby providing universal compatibility with various guitar models. Chord identifying information and finger placement markers are disposed on the body of each chord card. In use, a selected chord card is inserted between the strings and fretboard, engaging the fret notches with the guitar frets, allowing the user to play the chord with the card in place to facilitate learning through visual and auditory modalities.

### BACKGROUND

### Field of the Invention

The present invention relates generally to the field of musical instruments and musical education devices. More specifically, the invention pertains to a universal system of chord cards designed to facilitate the learning and playing of guitar chords on various guitar models.

### Description of Related Art

Learning to play guitar chords is a fundamental skill for beginner guitarists. However, the process of memorizing chord fingerings and building muscle memory can be challenging and time-consuming. Traditional methods of learning chords, such as studying chord diagrams or following instructional videos, often require the student to constantly refer back to reference materials, disrupting the flow of practice.

To address this issue, various guitar learning aids have been developed. One such device is disclosed in U.S. Pat. No. 7,468,478 B2 to Garrett. The Garrett patent describes a guitar playing assist apparatus comprising a thin, flat body that can be pressed onto the guitar neck and fretboard to form chords. The device includes a key pad on the back side and a chord scale on the front side to guide finger placement. While the Garrett device provides a physical template for playing chords, it has several limitations. The device is not designed to be universally compatible with different guitar models, as the spacing and dimensions of the keypad and chord scale may not align properly with the frets on some guitars. Additionally, the device does not allow the user to strum the strings and hear the chord sound while the device is in place, an important feature for ear training and auditory learning.

Another guitar learning aid is disclosed in U.S. Patent Application Publication No. 2006/0000342 A1 to Haney. The Haney publication describes a slide rule device that can be positioned on the guitar neck to display chord fingerings. However, like the Garrett device, the Haney slide rule is not adaptable to different guitar neck dimensions and fret spacings. Moreover, the slide rule device does not provide a means for the user to actually play the chord while the device is in position.

The present invention seeks to overcome the limitations of the prior art by providing a universal guitar chord learning system that is compatible with various guitar models and allows users to play and hear chords with the learning aid in place. The inventive system comprises a set of chord cards with fret-engaging notches and finger placement markers that can be inserted between the strings and fretboard of a guitar. The chord cards are designed to fit securely on guitar necks of different dimensions, and the notches are spaced to accommodate variations in fret spacing. By using the inventive chord cards, students can quickly learn and memorize chord fingerings while also training their ears to recognize the sound of each chord. The present invention represents a significant advance over prior art guitar learning devices, as it provides a versatile, universal solution that enhances the learning experience for beginner guitarists.

### SUMMARY

The present invention is directed to a universal guitar chord learning system that facilitates the learning and playing of guitar chords on various guitar models. The system comprises a plurality of chord cards, each having a thin, flat body configured to be removably inserted between the strings and fretboard of a guitar without interfering with the vibration of the strings. The chord cards include a configuration of fret-engaging notches along the peripheral edges, arranged to securely attach to the frets of guitars having different fret spacings and dimensions. This universal compatibility allows the chord cards to be used with a wide range of guitar models.

Each chord card features chord identifying information and finger placement markers printed on the body. The finger placement markers, which may be color-coded dots, indicate where the user should place their fingers on the strings to play the corresponding chord. The chord identifying information may include the chord name and a graphical representation of the chord's musical notation.

In use, the player selects a chord card corresponding to the guitar chord they wish to learn and inserts it between the strings and fretboard, engaging the fret notches with the guitar's frets. The user then places their fingers on the strings as indicated by the finger placement markers and strums the strings to produce the desired chord sound. By hearing the chord played while the card is in position, the user can aurally learn the chord and associate the fingering pattern with the resulting sound.

The inventive chord card system provides several advantages over prior art guitar learning devices. The universal design of the fret-engaging notches allows the cards to be used with various guitar models, eliminating the need for model-specific learning aids. Additionally, the ability to play the chord with the card in place enhances the learning experience by engaging both visual and auditory learning modalities. The chord cards are made of durable, resilient materials to withstand repeated use and can be conveniently stored on a ring or in a case when not in use.

In summary, the present invention provides a versatile and effective tool for learning guitar chords that is compatible with a wide range of guitar models. By using the inventive chord cards, beginner guitarists can quickly memorize chord fingerings, train their ears to recognize chord sounds, and develop the skills necessary to play guitar chords with confidence.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a perspective view of an embodiment of a chord card for a universal guitar chord learning system inserted below the frets of a guitar fretboard.

FIG. 2 depicts an embodiment of the steps for using the chord card to learn and play a guitar chord.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

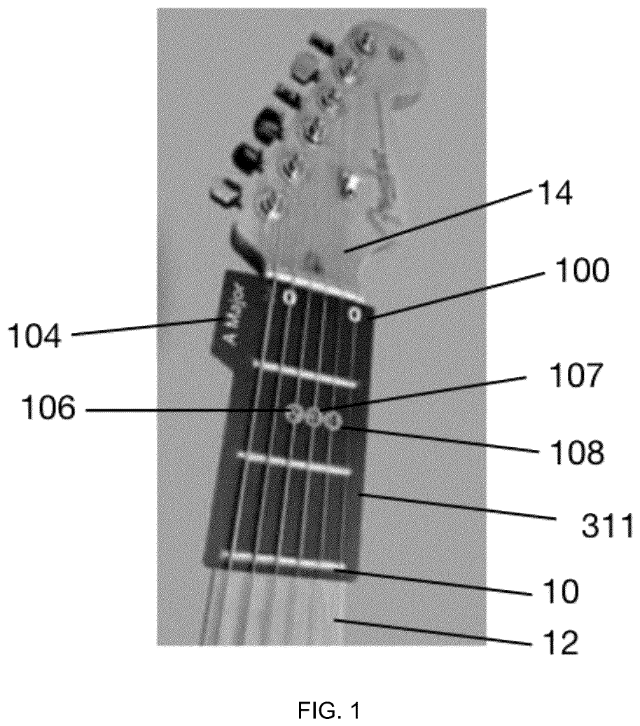

FIG. 1 illustrates an embodiment of a perspective view of a chord card (100) for a universal guitar chord learning system inserted below the frets (10) of a guitar fretboard (12). The chord card (100) comprises a planar body (102) configured to be removably inserted between the strings (14) and the fretboard (12) of the guitar. The chord name, in this example “A Major”, is displayed on a tab cutout (104) at the top of the chord card (100). Three blue dots (106, 108, 110) on the surface of the planar body (102) show where to place the user's fingers to play the A Major chord. The numbers (1, 2, 3) on the dots (106, 108, 110) indicate which finger to place on each dot, with 1 corresponding to the index finger, 2 corresponding to the middle finger, and 3 corresponding to the ring finger. The planar body (102) further comprises a plurality of fret cut-outs (112) disposed along the edges of the planar body (102). The fret cut-outs (112) are configured to engage with one or more frets (10) of the guitar to secure the chord card (100) in a fixed position between the strings (14) and the fretboard (12).

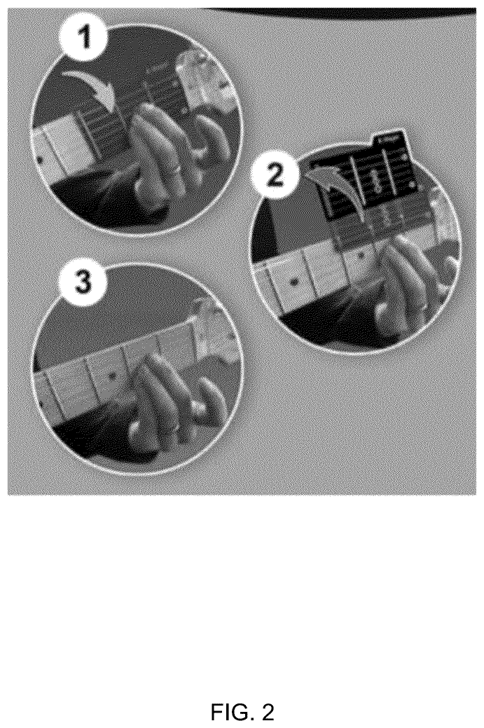

FIG. 2 depicts the steps for using the chord card (100) to learn and play a guitar chord. In step 1, the chord card (100) is inserted under the strings (14) and between the frets (10) of the guitar fretboard (12). The user's fingers (120, 122, 124) are placed on the strings (14) according to the blue dots (106, 108, 110) on the surface of the chord card (100). Specifically, the index finger (120) is placed on dot 1 (106), the middle finger (122) is placed on dot 2 (108), and the ring finger (124) is placed on dot 3 (110). In step 2, the chord card (100) is pulled out from under the strings (14) and removed from the fretboard (12) while the user's fingers (120, 122, 124) remain in the correct positions on the strings (14). Step 3 shows the user's fingers (120, 122, 124) placed in the proper positions on the strings (14) and fretboard (12) to play the A Major chord that was displayed on the tab cutout (104) at the top of the chord card (100). By depressing the strings (14) at the finger placement positions indicated by the blue dots (106, 108, 110) and strumming the strings (14), the user can produce an audible A Major chord sound, thereby facilitating the learning and memorization of the chord shape and fingering. In one embodiment, the planar body (102) of the chord cards (100) is made of a durable, flexible plastic material that can withstand repeated insertion and removal between the strings (14) and fretboard (12) without damage. The plastic material may be a thermoplastic polymer such as polypropylene, polyethylene, or a polyamide. The material is selected to have sufficient stiffness to maintain its shape and engage with the frets (10), while also being thin and flexible enough to fit between the strings (14) and fretboard (12) without significantly altering the action or playability of the strings.

Each chord card (100) may further comprise a chord name printed on the surface of the planar body (102), such as on the tab cutout (104). The chord name corresponds to the guitar chord produced when the strings (14) are depressed at the finger placement positions indicated by the visual indicia, such as the blue dots (106, 108, 110). Having the chord name prominently displayed facilitates quick identification and selection of the desired chord card (100) for the chord to be learned or played.

In some embodiments, the plurality of fret cut-outs (112) are arranged in a staggered or alternating pattern along the edges of the planar body (102). This staggered configuration allows the fret cut-outs (112) to engage with frets (10) on various guitar models that have different fret spacings and dimensions. By accommodating a range of fret spacings, the chord cards (100) can be used as a universal learning tool compatible with many different types and sizes of guitars.

The planar body (102) of the chord cards (100) may have a thickness between about 0.5 millimeters and 2 millimeters. This thickness range provides a balance between being thin enough to fit between the strings (14) and fretboard (12) without excessive interference, while being thick enough to have some rigidity for easy handling and fret engagement. The thin profile allows the chord cards (100) to be inserted and removed without significantly changing the action or feel of the strings (14) against the fretboard (12).

The universal guitar chord learning system may further comprise a storage case configured to hold and organize the plurality of chord cards (100) when not in use. The storage case can have labeled slots or compartments for sorting the chord cards (100) alphabetically by chord name, or by chord type such as major, minor, seventh chords, etc. This allows a user to quickly find the desired chord card, while keeping the cards together and protected. The case may be made of plastic, wood, cardboard or other suitable materials.

A plurality of chord cards (100) may be provided with the universal guitar chord learning system, with different cards for many commonly used chords. The chord cards (100) can include major chords, minor chords, seventh chords, suspended chords, and other variations in different keys. Some examples of chords that may be included are: A Major, C Major, D Major, E Major, G Major, A Minor, D Minor, E Minor, C7, D7, G7, Asus4, Dsus4, and so on. Having a wide selection of chord cards (100) allows users to learn a variety of chords and practice smooth transitions between them.

The fret engaging notches (112) along the peripheral edges of the chord card body (102) may be V-shaped cutouts. The V-shape allows the notches (112) to wedge onto the frets (10) and hold the chord card (100) in place while in use. The notches (112) can be sized and spaced to snugly fit against frets (10) of various common sizes and spacings used on different guitar models. This ensures a secure, temporary attachment of the chord card (100) to the fretboard (12) during use.

In some embodiments, the chord cards (100) are color-coded based on the type of chord. For example, major chords may have a red color theme, minor chords a blue color, seventh chords a green color, and so on. The finger placement markers such as dots (106, 108, 110) can also be color-coded to match the chord type. Color-coding allows users to quickly distinguish and grab the correct chord card (100) for the type of chord they want to learn or play, which is especially helpful when using multiple cards in a learning session.

The body (102) of each chord card (100) is made of a resilient plastic material that can flex and withstand the forces of repeated insertion, removal, and fret engagement without cracking, breaking, or permanently deforming. The material can be a polycarbonate, ABS, or nylon polymer that provides high strength and durability in a thin card format. Resistance to humidity and temperature changes is also desirable so the chord cards (100) maintain their shape and functionality in different environments.

The universal guitar chord learning system can include an instructional booklet that provides guidance on how to use the chord cards (100) effectively. The booklet may include exercises for learning individual chords and transitioning between chords. It can also provide some sample songs, melodies, or progressions that can be played using the chords learned from the chord cards (100). The instructional booklet aims to facilitate a structured learning approach to build foundational guitar skills using the chord card system.

A plurality of chord cards (100) covering all the commonly used major, minor, and seventh chords can be bundled together as a complete set. This allows beginners to learn all the essential chords needed to start playing popular songs. Additional chord cards (100) for more advanced chords, such as extended chords, altered chords, and chords with added notes can be provided as expansion packs to the base set. Having a comprehensive collection of chord cards (100) supports a progressive learning path for guitar students.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A universal guitar chord learning system, comprising:
a plurality of chord cards, each chord card comprising:
a planar body configured to be removably inserted between strings and a fretboard of a guitar;
a plurality of fret cut-outs disposed along edges of the planar body, the fret cut-outs configured to engage with one or more frets of the guitar to secure the chord card in a fixed position between the strings and the fretboard; and
visual indicia on a surface of the planar body indicating finger placement positions corresponding to a guitar chord;
wherein the plurality of fret cut-outs are arranged in a universal configuration adapted to engage with frets of guitars having different fret spacings and neck dimensions, such that the chord cards are compatible with multiple guitar models; and
wherein the chord cards, when inserted between the strings and fretboard, allow a user to play the corresponding guitar chord by depressing the strings at the indicated finger placement positions while strumming the strings, thereby producing an audible chord sound to facilitate learning of the guitar chord.

2. The universal guitar chord learning system of claim 1, wherein the visual indicia comprises color-coded dots indicating finger placement positions for a user's index, middle, ring, and pinky fingers.

3. The universal guitar chord learning system of claim 1, wherein the planar body is made of a durable, flexible plastic material that can withstand repeated insertion and removal between the strings and fretboard without damage.

4. The universal guitar chord learning system of claim 1, wherein each chord card further comprises a chord name printed on the surface of the planar body, the chord name corresponding to the guitar chord produced when the strings are depressed at the indicated finger placement positions.

5. The universal guitar chord learning system of claim 1, wherein the plurality of fret cut-outs are arranged in a staggered pattern along the edges of the planar body to accommodate different fret spacings on various guitar models.

6. The universal guitar chord learning system of claim 1, wherein the planar body has a thickness between 0.5 mm and 2 mm to allow insertion between the strings and fretboard without significantly altering the strings' action.

7. The universal guitar chord learning system of claim 1, further comprising a storage case configured to hold the plurality of chord cards when not in use, the storage case having labeled slots for organizing the chord cards by chord name or type.

8. The universal guitar chord learning system of claim 1, wherein the plurality of chord cards includes cards for major, minor, seventh, and suspended chords in various keys.

9. The universal guitar chord learning system of claim 1, wherein each chord card is double-sided, with a first side displaying the visual indicia for a first chord and a second side displaying visual indicia for a related chord.

10. The universal guitar chord learning system of claim 1, further comprising an instructional booklet illustrating how to use the chord cards and providing exercises and songs that can be played using the cards to facilitate guitar learning.

11. A method of learning guitar chords using a universal chord card system, the method comprising:
providing a plurality of chord cards, each chord card having:
a thin, flat body adapted to fit between guitar strings and a fretboard without interfering with vibration of the strings;
a configuration of fret engaging notches along peripheral edges of the body, the configuration of fret engaging notches arranged to allow the chord card to securely attach to frets of various guitar models having different fret spacings and dimensions; and
chord identifying information and finger placement markers printed on the body;
selecting, from the plurality of chord cards, a chord card corresponding to a guitar chord to be learned;
inserting the selected chord card between the strings and the fretboard of a guitar such that the fret engaging notches mate with corresponding frets to fix the chord card in position;
placing fingers on the strings at positions indicated by the finger placement markers on the chord card;
strumming the strings while the chord card is in position to produce an audible guitar chord sound; and
listening to the audible guitar chord sound produced to aurally learn the guitar chord;
wherein the chord cards are universally compatible with multiple different guitar models to enable learning of guitar chords on various guitars using the same chord card system.

12. The method of claim 11, wherein the fret engaging notches are V-shaped cutouts sized and spaced to engage with frets on guitars having varying fret dimensions and spacings.

13. The method of claim 11, wherein the chord cards are color-coded based on chord type to facilitate visual recognition and selection of desired chord cards.

14. The method of claim 11, wherein the chord identifying information printed on each chord card includes the name of the chord and a graphical representation of the chord's musical notation.

15. The method of claim 11, wherein the finger placement markers comprise colored dots indicating where to place each finger on the strings.

16. The method of claim 11, wherein the body of each chord card is made of a durable, resilient plastic material able to withstand repeated insertion and removal between the strings and fretboard.

17. The method of claim 11, further comprising the step of progressively memorizing the finger placements indicated on the chord card and playing the chord without the chord card in position.

18. The method of claim 11, further comprising storing the plurality of chord cards on a ring or in a case when not in use to keep them organized and readily accessible.

19. The method of claim 11, wherein the plurality of chord cards includes cards for all commonly used major, minor, and seventh chords.

20. The method of claim 11, wherein the chord cards are adapted for use with right-handed and left-handed guitars.
